(19) United States
(12) Patent Application Publication
(10) Pub. No.: US 2004/0176262 A1
(43) Pub. Date: Sep. 9, 2004

(54) Methods and compositions for drains and delivery lines

(76) Inventor: Cory S. Hammock, Macon, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/664,592

(22) Filed: Sep. 18, 2003

Related U.S. Application Data
(60) Provisional application No. 60/411,587, filed on Sep. 18, 2002.

(51) Int. Cl. C11D 1/00

(52) U.S. Cl. 510/195

(57) ABSTRACT

Drain and delivery line cleaning and maintaining compositions are provided for use in inhibiting the growth of microorganisms, to keep the drains free flowing and to prevent the need for removal of build-up that results from the formation of deposits produced by microorganisms, including acetic acid bacteria found in drains and delivery lines. Also provided are methods for cleaning and maintaining drains and delivery lines such as those such as those found in soda fountains, bars, beer brewery lines, and ice machines, in which sugar-rich and alcohol fermentation environments exist comprising administering an antimicrobially effective amount of the compositions of the present invention.

Additionally, processes are provided for delivering drain and delivery line cleaning and maintaining compositions utilizing aqueous forms of such organic acid cleaning compositions, which inhibit the growth of acetic acid bacteria.

### CROSS-REFERENCE TO RELATED APPLICATIONS

This application claims priority to U.S. Provisional Patent Application Serial No. 60/411,587, filed on Sep. 18, 2002, which is herein incorporated in its entirety.

### FIELD OF THE INVENTION

The present invention relates to the field of cleaning compositions and to processes for utilizing such compositions to clean and maintain drains and delivery lines. More particularly, the present invention is directed to the use of such compositions, prepared from at least one organic acid, to keep drains and delivery lines, such as those found in soda fountains, bars, beer brewery lines, and ice machines, free flowing.

### BACKGROUND OF THE INVENTION

Drains and delivery lines used in restaurants, bakeries, breweries, and soft drink manufacturing require routine treatment to prevent or remove deposits produced by microorganisms commonly found in such sugar, yeast and alcohol-rich environments. Traditional approaches to controlling or eliminating the problem of microorganisms and deposits in sugar or alcohol enriched environments typically have included contacting the drain system with highly corrosive chemicals, such as concentrated hydrochloric acid, concentrated sulfuric acid, sodium hypochlorite, sodium silicate, chlorine bleach, phenylmercuric acetate, pentachlorophenol, tributyltin oxide, isocyanurates, or sodium hydroxide. However, these treatments have proven ineffective, impractical, or incapable of removing deposits, and they have several drawbacks associated with their use. Most of these chemicals are toxic to many organisms, including humans. Their toxicity makes them very dangerous during handling, and they contaminate and pollute if they are discharged into the environment. In addition to the problems engendered by toxicity, many of these toxic and hazardous chemicals can corrode and damage the drain systems.

Mechanical water jetting and rotor rooting are nontoxic alternatives to the chemical treatments described above. Of these, water jetting is preferred because it is less likely to cause damage to the drain systems. However, neither method is an effective, acceptable treatment to prevent or remove bacterial cellulose deposits in drain systems. Bacterial cellulose accumulates rapidly in susceptible drain systems, and to keep such drains completely clear by these mechanical means requires frequent treatments. The frequent interruption in drain service occasioned by jetting or rooting makes them impractical. In addition, both methods involve significant manual labor and equipment downtime, adding considerably to the cost of removing the deposits. Cost and inefficiency make jetting or rooting especially uneconomical as prophylactic treatments. The result is that many drains having microbial deposit problems are ineffectively and infrequently treated and therefore function at an unhealthy or severely reduced capacity or not at all.

One non-mechanical method for treating aqueous drain systems proposes a process for degrading fibrous cellulose materials by contacting the material with a composition comprising a cellulase enzyme, sodium bicarbonate, and citric acid. However, this method does not use an enzyme having activity specific to polymeric cellulose typically produced by microorganisms such as Acetobacter bacteria, and the enzyme concentrations disclosed are too low for effectively treating cellulose deposited by such microorganisms. Moreover, compositions typically used in this process contain large quantities of sodium chloride, which drastically reduces cellulase enzyme activity.

Another method for cleaning drain systems includes using enzymatic drain cleaner compositions composed of a metal salt of carbonic acid, glucono-delta-lactone, and a mixture of enzymes, including amylase, protease, lipase, pectinase, and cellulase. These compositions suffer the same drawbacks discussed above, i.e., they do not address the polymeric bacterial cellulose substrate produced by microorganisms such as Acetobacter bacteria, and they contain significant amounts of sodium chloride, which inhibits enzyme activity under the conditions where such bacterial cellulose deposits are found. Moreover, the disclosed compositions contain relatively high concentrations of amylase and lipase enzymes specific to degrade starchy, greasy, or fatty materials rather than bacterial cellulose.

Another method uses a detergent drain pipe cleaning composition comprising a lipocatabolic lipase, an imbibing agent such as sodium bicarbonate, and an N-acyclic amino acid, but no cellulase enzyme. Thus, this composition is not specific to cellulose produced by microorganisms such as Acetobacter bacteria. Some drain cleaning systems use enzymatic cleaners containing biologically derived acid cellulose enzyme possessing hydrolytic activity specific to β-glucosidic bonds in cellulose produced by specific bacteria to address bacteria buildup.

Methods for treating drains and delivery lines in restaurants, bakeries, breweries, and soft drink manufacturing with solutions of harsh and or toxic chemicals such as sodium hypochlorite, alkali hydroxides, enzymes and the like, as described above, have proven difficult. The use of such chemicals, while effective, presents certain problems specifically due to the corrosive and toxic nature of such chemicals. Mechanical or enzymatic treatments also have been found to be expensive and to require frequent disassembly for treatments. Therefore, there exists a need in the art for methods and compositions for cleaning and maintaining drains and delivery lines which overcome these problems.

### SUMMARY OF THE INVENTION

The present invention comprises compositions and methods of using the compositions for preventing or removing deposits, particularly cellulose deposits, produced by microorganisms in drains and delivery lines. Compositions of the present invention comprise organic acids that are effective in clearing the drains of deposits, eliminating the presence of microorganisms, and preventing microbial growth and deposits. The compositions optionally comprise one or more of a chelating agent, a polymeric dispersing agent, an alkali counter ion, a humectant, a preservative agent, or mixtures thereof. The compositions and the methods for using the compositions are safe, economical, and do not require the use of chemicals that are hazardous or toxic to humans.

The present invention further comprises methods for preventing or removing deposits, particularly cellulose deposits, produced by microorganisms such as Acetobacter bacteria, in aqueous systems comprising administering an effective amount of a cleaner composition.

The present invention further comprises methods for preventing or removing deposits, particularly cellulose deposits, produced by microorganisms such as Acetobacter bacteria on non-aqueous surfaces capable of forming deposits, particularly those exposed to sugars, yeasts and/or alcohol, comprising administering an effective amount of a composition of the present invention.

The present invention also comprises methods and devices for delivering a cleaning composition to an aqueous system. One embodiment of a device used with the methods of the present invention comprises using a drip wick system. A method of the present invention comprises providing a reservoir of a cleaning composition, a wick of sufficient diameter and length to deliver the composition from the reservoir to the aqueous system, and a wick tube enclosure suitable for housing the wick; and continuously dripping the cleaning composition through the wick to the aqueous system. The compositions of the present invention can be used with any methods for delivering an effective amount of the compositions to the site or sites of deposits or microbial growth. Methods and devices for dispensing liquids into drain lines or delivery lines are contemplated by the present invention.

### DETAILED DESCRIPTION OF THE INVENTION

A slimy, gelatinous mass is produced by microorganisms such as Acetobacter bacteria. Components of this mass include cellulose, glycoproteins, or other complex carbohydrates. The mass is found in nature when such microorganisms come into contact with decomposing fruit or other sugar- or alcohol-enriched matter. Microorganisms thrive in natural or artificial sugar- or alcohol-enriched acidic environments, such as are found in flowers, fruits, leaves, saps, honey, vinegar, cider, wine, beer, syrups, fruit juices, and the like. Fermentation of sugar by the microorganism, such as Acetobacter bacteria, results in a catalyzed biosynthesis of fibrils, which accumulate around the bacteria cells and result in the mass. It is this mass that forms deposits at the site of the microbial fermentation.

For example, Acetobacter zymomonas will ferment sucrose to ethanol via glucose within 8 to 12 hours of contacting the sucrose, which creates a highly suitable medium for the continued development of the bacterium. Glucose forms the repeating cellobiose sub-units of cellulose, which is a beta-1,4′ polymer of D-glucose having beta-glucosidic linkages. The general reaction scheme is believed to be as follows:

C₁₂H₂₂O₁₁ (sucrose)→C₆H₁₂O₆ (glucose)+C₆H₁₂O₆ (fructose)

C₆H₁₂O₆ (glucose)→C₂H₅OH (ethanol)+CO₂

C₂H₅OH (ethanol)→CH₃COOH (acetic acid)

During fermentation, this acetic acid bacterium will begin to multiply after 2-3 days, utilizing the glucose or sucrose that is present in the early stages of the fermentation.

The cellulose strand secreted by the subspecies Acetobacter xylinium, Gluconacetobacter hansenii ATCC 23769, is a particularly unusual product. Under appropriate conditions, A. xylinium will synthesize cellulose from glucose into a ribbon of cellulose that is 0.05 to 0.1 μm diameter, at a rate of approximately 2 μm per minute. The ribbons of cellulose appear to polymerize and crystallize into larger strands, which provide a floating mat or pellicle that furnishes the aerobic Acetobacter with a surface on which to grow in an aqueous medium.

One particularly troublesome manifestation of polymeric microbial material, such as cellulose, occurs in sugar or alcohol enriched drain pipes such as those connected to soft drink or beverage stations, including alcoholic beverages in food service, bar, and hotel establishments. In this highly favorable environment, Acetobacter bacteria and other microorganisms easily produce microbial materials, including polymers such as cellulose, glycoproteins or other complex carbohydrates, which build up in the drains, its attached plumbing, and the drain system, and ultimately can block the flow of material within the system. Similar problems can exist in the beverage delivery tubing and clog the delivery of the liquids. Likewise, surfaces exposed to sugar or alcohol enriched foods or other products may also become coated with microbial material. Presently, there are no suitable, effective, safe, non-polluting, and non-corrosive solutions to this problem.

The present invention is directed to compositions and methods to prevent or remove microbial deposits produced in aqueous systems by microorganisms such as, for example, Acetobacter bacteria. One embodiment of the compositions of the present invention comprises non-enzymatic, non-detergent compositions. In one such embodiment, a non-enzymatic composition of the present invention comprises an organic acid capable of inhibiting microbial growth, killing microorganisms, and preventing colonization of microorganisms. The present invention contemplates organic acids having higher hydrophobicity and that do not dissociate readily. Higher hydrophobicity is useful because the microbial cell wall normally contains lipid material, and hydrophobic organic acids interact with this lipid material in a way that disrupts microbial activity. Acids that dissociate readily are not effective in antimicrobial activity because they are generally less hydrophobic.

The present invention is also directed to compositions and methods to prevent or remove microbial deposits produced by microorganisms on surfaces such as those found in food processing. Processing equipment having surfaces exposed to sugars, yeasts and alcohols may develop deposits due to microbial exposure of the surfaces. The composition of the present invention is used to prevent such deposits and/or to remove existing deposits.

The cleaning compositions of the present invention comprise at least one organic acid capable of killing microorganisms, inhibiting the growth of microorganisms and/or preventing the attachment or colonization of microorganisms. Additionally, the compositions optionally include one or more of a chelating agent, a polymeric dispersing agent, an alkali counter ion, a humectant, and a preservative agent. The compositions may further comprise enzymes capable of activity at the acidic environment of the compositions of the present invention. The present invention further comprises methods for cleaning and maintaining drains and delivery lines comprising administering a composition comprising at least one organic acid capable of inhibiting the growth of microorganisms, preventing the colonization of microorganisms, or killing microorganisms. One embodiment comprises administering an effective amount of a composition comprising at least one organic acid to the drain or delivery line via a drip or wick system. Such delivery can be continuous or for discrete periods of time.

As used herein, the term “organic acid” includes organic acids known to those skilled in the chemical arts and other reagents that produce H+(aq) ions in aqueous solution. Non-limiting examples of organic acids contemplated by the present invention include acetic acid, aminoacetic acid, ascorbic acid, benzoic acid, citric acid, gluconic acid; hydroxyacetic acid, hydroxybenzoic acid, lactic acid, formic acid, oxalic acid, propanoic acid, maleic acid salicylic acid, succinic acid, hydroxysuccinic acid, tartaric acid, and the like.

With regard to the optional ingredients for inclusion in the cleaning compositions of this invention, suitable polymeric dispersing agents for use in the compositions of the present invention include water-soluble polymeric and co-polymeric compounds such as, but not limited to, polyacrylic acid; polyacrylic acid/maleic acid copolymers; polymethacrylic acid, polyaspartic acid and the like and mixtures thereof.

Alkali counterions for use in the compositions of the present invention include, but are not limited to, sodium ions, potassium ions, calcium ions, magnesium ions, ammonium and amine ions (for example, from ammonium hydroxide, isopropylamines, and alkanolamines), and the like and mixtures thereof.

Chelating agents include, but are not limited to, water soluble compounds such as ethylenediaminetetraacetic acid; diethylenediaminepentaacetic acid; nitrilotriacetic acid; hydroxyethylenediaminetriacetic acid; iminodisuccinate acid; aminotrismethylenephosphonic acid; hexamethylenediaminetetramethylenephosphonic acid; diethylenetriaminepentamethylene-phosphonic acid and the like and mixtures thereof.

Humectants useful in the compositions of the present invention include a variety of water soluble compounds including, but not limited to, glycols such as ethylene glycol, diethylene glycol, triethylene glycol, propylene glycol, dipropylene glycol, tripropylene glycol and the like and mixtures thereof; as well as, polyethylene glycols, glycerol, sorbitol and the like and mixtures thereof.

Suitable solubilizing agents include a variety of solvents including but not limited to alcohols such as, but not limited to, methyl alcohol, ethyl alcohol, isopropyl alcohol, propyl alcohol and the like; glycol ethers (including methyl, ethyl, propyl, isopropyl, butyl, phenyl, and ethylhexyl ethers) and glycol ether esters of glycols (such as ethylene glycol, diethylene glycol, triethylene glycol, propylene glycol, dipropylene glycol, tripropylene glycol and the like) including diethylene glycol mono butyl ether and diethylene glycol mono butyl ether acetate and mixtures thereof.

With regard to the optional ingredients for inclusion in the cleaning compositions of the present invention, any known preservative may be employed in the compositions of this invention provided that the preservative passes standard screening for challenge testing and storage stability of cleaning compositions containing the preservative. Suitable preservative agents for use in the present invention include a variety of chemical compounds with the ability to impart a resistance to microbial contamination in order to assure product safety and integrity over the useful life of the product. Such preservative agents include but are not limited to 1,3-dihydroxymethyl-5-5-dimethylhydantoin (DMDM Hydantoin); 1,2-benzisothiazolin-3-one; 5-chloro-2-methyl-4-isothiazolin-3-one; 2-methyl-4-isothiazolin-3-one; 3-iodo-2-propynyl butyl carbamate; phenoxyethanol; 2-bromo-2-nitropropane-1,3-diol; methyl paraben; propyl paraben; isopropyl paraben; butyl paraben; isobutyl paraben; diazolidinyl urea, hydroxymethylglycinate alkyl dimethyl benzyl ammonium chloride, alkyl ethyl benzyl ammonium chloride, didecyl benzyl ammonium chloride, dioctyl benzyl ammonium chloride, and decyl octyl benzyl ammonium chloride, and mixtures thereof.

The terms “drains and delivery lines” generally refer to any system used for transporting matter from one point to another. More specifically, the term “drain” refers to any channel used for carrying liquid. Particular drains contemplated by the present invention include, but are not limited to, plumbing lines, particularly those used to transport aqueous material from ice machines, soda fountains, beer taps, bar systems, air conditioners, food processing equipment, restaurant equipment, and the like. The term “delivery line” generally includes any channel or pathway capable of transporting material from one place to another, such as, for example and not limitation, transporting aqueous material to an ice machine, soda fountains, beer taps, bar systems, air conditioners, food processing equipment, restaurant equipment, and the like. The term includes enclosed systems, such as, but not limited to, drains and the like, and it further contemplates open systems such as, but not limited to, gutters, conveyor belts and systems, exchangers, bowls, mixers, or other types of food processing equipment, aquaducts, watercourses or channels in which aqueous or non-aqueous materials can travel.

The term “microorganism” includes any living organism too small to be seen with the naked eye. The term includes, but is not limited to, bacteria, fungi, protozoans, viruses, molds, mildew, yeasts, and algae.

The term “deposits” as used herein includes any solid or semi-solid material capable of forming in an environment rich in sugar, starch, alcohol, yeast, or microorganisms or other aqueous environments. The term includes, but is not limited to, cellulose, glycoproteins, complex carbohydrates, minerals and the like.

The term “antimicrobial” as used herein refers to properties of the present composition which kill microorganisms, inhibit the growth of microorganisms, and/or prevent the attachment and/or colonization of microorganisms.

The terms “cleaning” and “maintaining” as used herein refer to eliminating existing deposits within the drains and/or delivery lines as well as preventing the formation of deposits. When treated with the compositions of the present invention, the drains, delivery lines or surfaces treated will be free of microorganisms and the deposits caused by microorganisms and the environments conducive to their growth. Additionally, the drains, delivery lines or surfaces treated with the compositions of the present invention will exhibit resistance to future growth and development of microorganisms and deposits.

Generally, in formulating aqueous drain and delivery line cleaning and maintaining compositions of the present invention, the following ranges of ingredients (as weight percentages per total weight of aqueous cleaning composition) may be used. These formulations are provided only as general guidelines and are not intended to limit the scope of the invention. For example, compositions of the present invention comprise organic acid in a range from about 0.01% to about 90.0% wt percentage/total wt, including from 0.01% to 85%, from 0.01% to 80%, from 0.01% to 75%, from 0.01% to 60%, from 0.01% to 50%, from 0.01% to 45%, from 0.01% to 35%, from 0.5% to 35%, from 0.5% to 30%, from 0.5% to 25%, from 1.0% to 25%, from 1.0% to 20%, from 1.0% to 15%, from 1.0% to 10%, and all ranges contained therein from about 0.01% to about 95.0%. An embodiment of the compositions comprises an organic acid concentration of 1.0% to 10.0%. Alkali counterions are added to the composition in a quantity sufficient to optimize the pH. The pH ranges for compositions of the present invention comprise ranges from about 1.0 to about 7.0, and all ranges in between, including from 1.0 to 6.0, from 1.0 to 5.0, from 1.0 to 4.0, from 2.0 to 4.0, from 2.0 to 3.0. An embodiment of the compositions comprises a composition with a pH range of 2.0 to 2.5.

Other components of the compositions of the present invention comprise dispersing agents, chelating agents, humectants, solubilizing agents, preservatives, and water. Dispersing agents comprise ranges from about 0.001% to 10.0% wt percentage of the total weight of the composition, with preferred embodiments comprising from 0.05 to 1.0% wt percentage. Chelating agents comprise ranges from about 0.01% to 5.0%, with preferred amounts ranging from 0.055 to 1.0% wt percentage. Humectants comprise ranges from 0.01% to 25.0% wt percent, with 0.05% to 5.0% as preferred embodiments. Solubilizing agents comprise ranges from 0.01% to 25.0%, with preferred embodiments comprising 0.05% to 5.0%. Preservatives and water are added in amounts to be effective and to adjust the weight percentage to 100%, respectively. Other composition components include, but are not limited to, enzymes having activity in acidic environments or in environments with a pH less than 7. Such components are added in amounts that are effective in altering the microbial deposits present or preventing formation of a deposit.

Drain and delivery line cleaning and maintaining compositions of the present invention can be prepared from concentrated stock solutions. In practice, these concentrated stock solutions are intended to be diluted to a desired concentration with water by an end user at the site of application of the cleaning composition, depending on the particular dispensing device or technique to be employed by the end user to introduce the composition. The concentrated stock solutions contain predetermined quantities (on a weight basis) of the desired ingredients so that upon dilution the resulting aqueous compositions are within the ranges taught herein. The concentrated stock solutions are normally diluted by a factor of from about 1:2 to about 1:256 to produce the aqueous composition for application to drain and delivery line cleaning and maintaining compositions. Preferably, the concentrated stock solutions are diluted by a factor of from about 1:2 to about 1:64 and, most preferably, from about 1:2 to about 1:16. For example, one or more stock solutions can be diluted to form a composition for cleaning or maintaining drains or delivery lines comprising, as a weight percentage, 1.0% to 10% lactic acid and optionally the composition has a pH of 2.0 to 2.5, and optionally includes at least one dispersing agent at 0.05 to 1.0%, and optionally at least one chelating agent from 0.01% to 5.0%, and optionally at least one humectant from 0.1% to 25.0%, and optionally at least one solubilizing agent in an amount from 0.01% to 25.0%.

In a preferred embodiment of the present invention, the drain and delivery line cleaning and maintaining compositions of this invention comprise lactic acid and a preservative. In this regard, it has been found that such compositions have the advantage of demonstrating superior inhibition of the growth of microorganisms, particularly acetic acid bacteria, compared to the use of corrosive and or toxic chemicals commonly used in prior art drain and delivery line cleaning and maintaining compositions. The superior inhibition of microorganisms demonstrated by the compositions and methods of the present invention provide a significant commercial advantage over products containing sodium hypochlorite, alkali hydroxides or enzyme-type products and the like, which present significant hazards to both humans and equipment. Because of the corrosive and/or toxic nature of such prior art methods and chemical compositions, dangers to humans consuming products run through the drains or delivery lines exist. In the present compositions, the use of an organic acid inhibits the growth of microorganisms, including acetic acid bacteria, without the negative impact inherent in the use of prior art methods.

The drain and delivery line cleaning and maintaining compositions of the present invention comprise mixtures of the following ingredients: least one organic acid that inhibits the growth of microorganisms, such as lactic acid; optional ingredients such as one or more of a polymeric dispersing agent, an alkali counter ion, a chelating agent, a humectant, and a preservative agent may also be included in the composition. In selecting an organic acid for incorporation into a formulation for a drain and delivery line cleaning and maintaining composition, several factors are considered including, but not limited to, efficacy, corrosiveness, toxicity, solubility in aqueous solutions, and the tendency to dry out and cause buildup on equipment. As necessary, optional formulation components are selected to provide an aqueous organic acid solution that performs satisfactorily in accordance with the present invention.

A preferred composition of the present invention comprises:

a) one or more of an organic acid

b) a polymeric dispersing agent such as water-soluble polyacrylic acids;

c) sufficient amount of alkali counterions such as sodium (Na), potassium (K), ammonium hydroxide (NH₄OH), isopropylamine and alkanolamines as necessary to maintain the pH of the composition in an optimum range, balancing the corrosive properties of the composition with the inhibition of the growth of acetic acid bacteria;

d) a water-soluble chelating agent such as water-soluble ethylenediaminetetraacetic acid;

e) a humectant agent such as one of various glycols;

f) a solubilizing agent such as alcohol; and

g) a preservative such as DMDM Hydantoin.

Specifically, the organic acids included in the present drain and delivery line cleaning and maintaining compositions of this invention have the effect of maintaining a drain and delivery line environment which inhibits the growth of microorganisms without the use of corrosive chemicals. Enzymes may be present in the compositions of the present invention as long as the enzymes are capable of activity in an acidic environment. The present invention may optionally contain surfactants, particularly non-ionic or anionic surfactants, though cationic or other surfactancts can also be used.

It is noted that to achieve the advantages found by employing the drain and delivery line cleaning and maintaining compositions of this invention, particularly the removal of microbial residues and the prevention of microbial growth, the compositions need to be applied at appropriate times and at quantities sufficient to maintain a drain and delivery line environment that is outside conditions that are optimum for the growth of microorganisms. Such optimum conditions typically develop over extended periods of non-use such as at night and over weekends. Thus, one method of the present invention comprises applying the compositions of the present invention during the times when the drain and delivery lines are not actively used.

The compositions of the present invention can be applied continuously over a period of from 0.1 to 144 hours. In one embodiment of the present invention, the compositions of the present invention are applied continuously over a period of from 2 to 100 hours; from 4 to 50 hours; or from 6 to 24 hours. For example, a composition can be applied continuously to maintain a drain system for an indefinite amount of time by refilling a reservoir holding the composition that is then dispersed continuously into the drain system.

In the process of the present invention, a composition may be applied using any application method that either maintains a drain and delivery line environment constant outside conditions optimum for the growth of microorganisms or introduces a predetermined amount of the composition at intervals during periods of non-use, such as at night and over weekends.

A process of the present invention comprises cleaning or maintaining a drain or delivery line by administering an effective amount of a composition of the present invention using a drip dispenser similar to that described in U.S. Pat. Nos. 5,271,560 and 5,368,200, which patents are incorporated by reference as if specifically set forth herein.

A process of the present invention further comprises cleaning or maintaining a drain or delivery line by administering an effective amount of a composition of the present invention using a dispenser system such as that described in U.S. Pat. No. 5,810,208 by incorporating a suitable concentration of the drain and delivery line cleaning and maintaining compositions of this invention.

A process of the present invention further comprises cleaning or maintaining a drain or delivery line by administering an effective amount of a composition of the present invention using a wick dispenser system such at that described in U.S. Pat. No. 5,364,027 by incorporating a suitable concentration of the drain and delivery line cleaning and maintaining compositions of this invention.

Any of the delivery methods described above or known in the art can be combined with a timer or a scheduled delivery mechanism to automatically deliver the compositions of the present invention to the drain or delivery lines in need of cleaning or maintenance. The dispenser has incorporated therein a timer or related device which can be set to begin a delivery cycle, such as a 24-hour delivery cycle, so as to pump the compositions of the present invention through the dispenser for a preset period of time over various intervals within the cycle. For example, a timer can be set at one point in the day, for example at noon, to activate and deliver the compositions of the present invention at a later point of the day, for example at midnight. This delayed activation allows delivery of the compositions of the present invention during times of non-peak use of the drains or delivery lines.

While the compositions and methods of the present invention prevent the formation of deposits, the compositions and methods also include the removal of established deposits. Removal of established deposits is effected by administering an effective amount of a composition of the present invention to a drain or delivery line having deposits therein. The compositions of the present invention not only clear the drains or delivery lines of deposits, but they also prevent the formation of of additional deposits. Such compositions and methods can be used alone or in combination with other known methods, such as mechanical methods, to remove deposits.

Unless otherwise defined, all technical and scientific terms used herein have the same meaning as commonly understood by one of ordinary skill in the art. All publications, patent applications, patents, and other references mentioned herein are incorporated by reference in their entirety. In addition, the materials, methods, and examples are illustrative only and are not intended to be limiting.

### EXAMPLES

### Example 1

To determine product efficacy and to optimize organic acid concentration, 0.05 ml solutions of organic acid compositions are placed at the center of agar plates, previously prepared by spreading bacterial cellulose producing bacterium Gluconacetobacter hansenii ATCC 23769 bacterial culture, grown to a predetermined optical density in mannitol broth (ATCC Medium 1) onto mannitol agar plates using a sterilized bacterial spreader and an inoculation turntable to spread the culture evenly onto each plate. Plates are inverted and incubated at optimum growth temperature for 18 hours. Zones of no growth indicate inhibition of Gluconacetobacter. Generally organic acid concentrations were optimized in the range of 2-5% by weight (aqueous solution).

### Example 2

A 5000 gram (g) sample of a drain and delivery line cleaning and maintaining composition in accordance with the present invention was prepared by blending, in laboratory scale apparatus, the following ingredients:

| Ingredients | Weight Percent (%) | Grams (g) |
|---|---|---|
| Water (Tap) | 94.8000 | 4740.00 |
| Lactic acid (80%) | 5.0000 | 250.00 |
| Didecyl quaternary ammonium | 0.1000 | 5.00 |
| chloride (80%) | | |
| Ethanol (190 Proof) | 0.3000 | 15.00 |
| DMDM Hydantoin (40%) | 0.1000 | 5.00 |
| Totals | 100.0000 | 5000.00 |

The mixing procedure employed in producing the 5000 g sample included initially weighing and incorporating 4,740.00 g water into a 5000 mL polypropylene beaker and then placing the beaker containing the water on a steel mixer base, inserting a Talboy agitator into the beaker and initiating agitation. Then, 250.00 g Lactic acid (80%), 5.00 g Didecyl quaternary ammonium chloride (80%), 15.00 g Ethanol, and 5.00 g DMDM Hydantoin (40%) were incorporated, in listed order, into the water under agitation. The resulting mixture was blended for 5 minutes, after which an 8-ounce (oz) portion of the 2500 mL sample mixture was collected and transferred for Quality Control (QC) testing (Lot no. L-014B-030608-872). Other portions of the mixture were collected and introduced into 32 oz. high-density polyethylene (HDPE) containers with a suitable closure to be used as Test Samples for the performance testing detailed hereinafter in Example 3.

The QC testing of the 8 ounce sample resulted in the following data:

Quality Control

| Property | Predetermined Ranges | Test Results |
|---|---|---|
| Appearance/Odor | Clear, colorless liquid | Pass |
| | with slight odor | |
| pH | 2.0-2.5 | 2.25 |
| Sp. Gravity @ 25° C. | 1.005-1.010 | 1.008 |

### Example 3

To simulate use of the drain and delivery line cleaning and maintaining composition of the present invention and to demonstrate the results achieved with the compositions of the present invention, Test Samples of the cleaning composition produced in Example 2, packaged in a 32 ounce containers were taken to a local restaurant which had been predetermined to regularly experience buildup due to the growth of acetic acid bacteria gluconobacter in soda fountain drain and delivery lines. The composition of the present invention was tested in the restaurant in order to compare results to the standard nightly clean out procedures (i.e. one cup of 6.25% sodium hypochlorite followed by one gallon of hot water).

For purposes of this comparative test, a drip dispenser system described in U.S. Pat. Nos. 5,271,560 and 5,368,200 was used to introduce the drain and delivery line cleaning and maintaining composition into the drain line of a fountain drain trough, with lead through an approximately 3′ section of flexible drain tubing to a collection container. The drip system was set to deliver approximately 1-2 mL/hour. The drip system was monitored every 48-72 hours to verify flow rate. During the duration of the 60-day test of Lot L-014B- 030608-872, results confirmed laboratory prediction that drain and delivery line cleaning and maintaining compositions of this invention are effective at maintaining the drain and delivery line clean and maintenance free.

Whereas this invention has been described in detail with particular reference to its most preferred embodiment, it is understood that variations and modifications can be effected within the spirit and scope of the invention, as described herein before and as defined in the appended claims. The corresponding structures, materials, acts, and equivalents of all means plus function elements, if any, in the claims below are intended to include any structure, material, or acts for performing the functions in combination with other claimed elements as specifically claimed.

What is claimed is:

1. A method for cleaning a drain or delivery line comprising administering a composition comprising at least one water soluble organic acid and, optionally, one or more of the following:
a) an alkali counter ion;
b) a water soluble chelating agent;
c) a water soluble dispersing agent;
d) a humectant;
e) a solubilizing agent; and
f) a preservative.

2. The method according to claim 1, wherein the composition is administered to the drain or delivery line via a drip or wick system.

3. The method according to claim 2, wherein the composition prevents the growth of or removes bacteria from the drain or delivery line.

4. The method according to claim 3, wherein the bacteria is an acetic acid bacteria.

5. The method according to claim 3, wherein the drain or delivery line is present in a drink fountain, bar tap, brewery line or ice machine.

6. The method according to claim 2, wherein the water soluble organic acid is selected from the group consisting of lactic acid, citric acid, aminoacetic acid, ascorbic acid, benzoic acid, gluconic acid, hydroxyacetic acid, hydroxybenzoic acid, formic acid, oxalic acid, propanoic acid, salicylic acid, succinic acid, hydroxysuccinic acid, and tartaric acid.

7. The method according to claim 6, wherein the water soluble organic acid is lactic acid.

8. The method according to claim 6, wherein the organic acid is present in an amount between 1.0 and 10 percent of the total composition.

9. The method according to claim 6, wherein the alkali counter ion is present in an amount sufficient to maintain a pH necessary to minimize corrosion.

10. The method according to claim 9, wherein the alkali counter ion is selected from the group consisting of sodium ions, potassium ions, calcium ions, magnesium ions, ammonium ions, amine ions and mixtures thereof.

11. A method for maintaining a drain or delivery line comprising administering an effective amount of a composition having a concentration of organic acid sufficient to inhibit the growth of bacteria, the composition comprising at least one water soluble organic acid and, optionally, one or more of the following:
a) an alkali counter ion;
b) a water soluble chelating agent;
c) a water soluble dispersing agent;
d) a humectant;
e) a solubilizing agent; and
f) a preservative.

12. The method according to claim 11, wherein the composition is administered to the drain or delivery line via a drip or wick system.

13. The method according to claim 12, wherein the bacteria is an acetic acid bacteria.

14. The method according to claim 13, wherein the drain or delivery line is present in a drink fountain, bar tap, brewery line or ice machine.

15. The method according to claim 12, wherein the water soluble organic acid is selected from the group consisting of lactic acid, citric acid, aminoacetic acid, ascorbic acid, benzoic acid, gluconic acid, hydroxyacetic acid, hydroxybenzoic acid, formic acid, oxalic acid, propanoic acid, maleic acid, salicylic acid, succinic acid, hydroxysuccinic acid, and tartaric acid.

16. The method according to claim 15, wherein the water soluble organic acid is lactic acid.

17. The method according to claim 15, wherein the organic acid is present in an amount between 1.0 and 10 percent of the total composition.

18. The method according to claim 15, wherein the alkali counter ion is present in an amount sufficient to maintain a pH necessary to minimize corrosion.

19. A composition comprising at least one water soluble organic acid and, optionally, one or more of the following:
a) an alkali counter ion;
b) a water soluble chelating agent;
c) a water soluble dispersing agent;
d) a humectant;
e) a solubilizing agent; and
f) a preservative.
